(19) United States
(12) Patent Application Publication
(10) Pub. No.: US 2025/0385534 A1
(43) Pub. Date: Dec. 18, 2025

(54) METHODS AND SYSTEMS FOR MANAGING BATTERY HEALTH

(71) Applicant: Comcast Cable Communications, LLC, Philadelphia, PA (US)

(72) Inventor: Ivan Ong, Philadelphia, PA (US)

(21) Appl. No.: 18/746,890

(22) Filed: Jun. 18, 2024

(51) Int. Cl. H02J 7/00; H01M 10/44

(52) U.S. Cl. CPC H02J 7/00712; H01M 10/443

(57) ABSTRACT

Methods, apparatuses, and systems are described for determining whether to charge a battery of a device based one or more parameters are described. A device may initially be fully charged in low power or sleep mode when it receives a power consumption event. Based on the power consumption event, the device may determine whether one or more parameter thresholds associated with the one or more parameters are satisfied and cause the device to charge the battery.

### BACKGROUND

A device that utilizes a rechargeable battery and that is receiving power from a charging source may be awakened throughout the day as a user of the device checks for notifications or simply observes basic information such as the time of the day. Such power consumptions events can typically involve quick surges of power that consume large amounts of charging power. These quick surges will at a minimum cause the device to double the input power and then taper to its charging rate. After these power consumption events, the device will return to a low power or sleep mode after a duration of inactivity, which could last anywhere between several seconds and several minutes. With these power consumption events occurring throughout the day, the battery of the device is constantly being subjected to quick, unnecessary surges of current to charge the battery for what may amount to a very trivial amount of charge removed from the battery. This causes the battery to be subjected to an unhealthy behavior of being rapidly surged with current and then quickly taken off the charging process within a short duration when the device goes back to sleep or low power mode. The constant repetitive nature of this cycle increases battery degradation, and thus, severely affects the battery's state of health and efficiency.

### SUMMARY

It is to be understood that both the following general description and the following detailed description are examples and explanatory only and are not restrictive. Methods, systems, and apparatuses for determining a manner of when to charge a battery are disclosed.

A device may experience a power consumption event while operating in low power or sleep mode while connected to a power source for charging a battery of the device. Based on the power consumption event, the device may determine whether one or more parameters satisfy one or more parameter thresholds and accordingly determine whether to charge the battery.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows an example system for determining whether to charge a battery of a device;

FIG. 2 shows an example system architecture of a device;

FIG. 3 shows an example process for charging a battery of a device;

FIG. 4 shows an example process for charging a battery of a device;

FIG. 5 shows a flowchart of an example method;

FIG. 6 shows a flowchart of an example method;

FIG. 7 shows a flowchart of an example method;

FIG. 8 shows a flowchart of an example method;

FIG. 9 shows a flow chart of an example method; and

FIG. 10 shows a block diagram of an example system and computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memristor, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

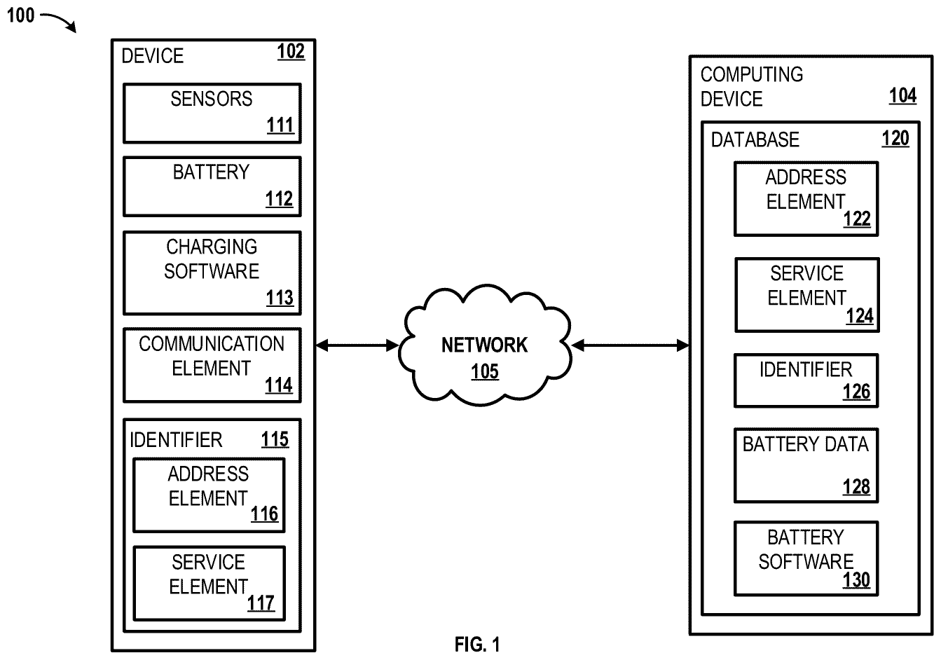

FIG. 1 shows an example system 100 for determining whether to charge a battery (e.g., battery 112) of a device (e.g., device 102). For example, the system 100 may be configured to determine whether to charge a battery of a device based on one or more parameters associated with the device and/or battery. The network and system 100 may be configured to provide services, such as network-related services, to a device (e.g., one or more devices 102). The system 100 may comprise one or more devices 102 that include one or more batteries 112 and a computing device 104. The computing device 104 may be disposed locally or remotely relative to the devices 102. The devices 102 and the computing device 104 may be in communication via a private and/or public network 105 such as the Internet or a local area network (LAN). The devices 102 may be in communication with a computing device 104 such as a centralized device or a server, for example. Other forms of communications can be used such as wired and wireless telecommunication channels.

The devices 102 may comprise electronic devices such as a computer, a smartphone, a laptop, a tablet, a set top box, a display device, a printer, a telephone, a cordless phone, a network node, a network device, a communication terminal, a transmitter, or other device capable of connecting to the network 105. The devices 102 may comprise sensors 111, a battery 112, charging software 113, a communication element 114, and an identifier 115. As an example, the battery 112 may be configured to supply power to the device 102. For example, the battery 112 may be included in the device 102 to provide power to the device 102. In an example, the devices 102 may be configured to receive power from a power source (e.g., via an outlet, an external battery back, etc.) in order to charge the batteries 112.

The sensors 111 may comprise a temperature sensor, an accelerometer, a barometric/atmospheric pressure sensor, a light/illumination sensor, a microphone or audio sensor, an altimeter, a GPS sensor, a gyroscope sensor, a moisture sensor, a current sensor, a voltage sensor, a resistance sensor, and so forth. The device 102 may be configured to use the sensors 111 to determine (e.g., measure) one or more parameters associated with the device 102 and/or the battery 112. The one or more parameters may comprise one or more of a movement of the device 102, an acceleration of the device 102, an orientation of the device 102, a rate of change of an orientation of the device 102, an altitude of the device 102, a rate of change of an altitude of the device 102, a temperature of the device 102, a rate of change of the temperature, a level of illumination detected by the device 102, a volume level of sound detected by the device 102, air pressure, a rate of change of air pressure 102, a moisture level of the device 102, a time of day 102, a location of the device 102, combinations thereof, and the like. In an example, the sensors 112 may be configured to measure a voltage of the battery 112, a resistance of the battery 112, a current associated with the battery 112, and/or a temperature of the battery 112. In an example, the sensors 111 may be configured to determine data associated with an environment around the battery 112 and/or the device 102 such as a temperature of the environment around the battery 112 and/or the device 102 and/or a presence of smoke (e.g., a smoke detector) or another chemical (e.g., natural gas, carbon monoxide, etc.).

The battery 112 may comprise any type of battery. For example, the battery 112 may comprise a rechargeable battery. The battery 112 may comprise any size, model, and/or type of battery. For example, the battery 112 may comprise a cylindrical battery (e.g., AAA, C, D, CR2, 2CR5, etc.), a rectangular battery (9 volt, 12 volt, etc.), a button cell battery (e.g., CR927,CR1220, CR2025, etc.), a zinc air cell battery (e.g., AC10, ZA13, A312, etc.), and so forth. The battery 112 may be made of any material such as alkaline, carbon zinc, Lithium-ion (Li-ion), Nickel Cadmium (Ni—Cd), Nickel-Metal Hydride (Ni-MH), Lithium-Manganese Dioxide (LiMnO₂), or any suitable battery. In an example, the battery 112 may comprise a plurality of batteries. For example, the plurality of batteries may be configured in one or more strings of the same batteries in series, parallel, or both series and parallel.

The battery 112 may have a storage capacity, which is the total amount of power (e.g., charge) that the battery 112 can store. The storage capacity of the battery 112 may change over time. For example, the battery 112 may comprise a rechargeable battery, wherein the storage capacity of the battery 112 may change over time as the battery 112 is used. For example, as the battery 112 is used (e.g., power is discharged from the battery 112, the battery 112 is charged, etc.), the capacity of the battery 112 may decrease due to the use. Thus, the capacity of the battery 112 may change over time, which may impact determining the amount of power remaining in the battery 112. Thus, the capacity of the battery 112 may be determined based on the use of the battery 112 to account for any change in the capacity of the battery 112. Accordingly, the device 102 may be configured to take into account the change in the capacity of the battery 112 when determining a remaining power left in the battery 112.

The battery 112 may have a battery life (e.g., state of health) associated with the battery 112. For example, the battery 112 may be a rechargeable battery that has a number of usage cycles (e.g., charged and discharged) that the battery 112 can have before the battery is no longer effective (e.g., does not hold a sufficient charge for the device's 102 intended use of the battery 112, such as supplying power to the device 102). As an example, the battery 112 may have a battery life of 10 usage cycles such that the battery 112 may be discharged and charged a total of 10 times before the battery 112 no longer holds a sufficient charge when fully charged due to a diminished capacity of the battery 112. The battery life (e.g., state of health) of the battery 112 may be indicated by a capacity of the battery 112. For example, when the capacity of the rechargeable battery is diminished (e.g., reduced) to the point of no longer being effective for its intended use, the life (e.g., state of health) of the battery 112 may be considered ended even though the battery 112 is still usable because the battery 112 still holds a charge. Thus, when the battery life (e.g., state of health) satisfies a threshold (e.g., when the capacity is reduced to the point that the threshold is satisfied), a notification may be generated and/or sent to indicate that the battery life (e.g., state of health) of the battery 112 is near the end of the effective life of the battery 112, and the battery 112 needs to be replaced. As an example, when the capacity of the battery 112 is reduced to a percentage (e.g., 50%, 60%, 70%, etc.) as compared to the capacity of the battery 112 when new (e.g., 100%), the notification may be generated and/or sent to indicate the that the battery 112 needs to be replaced.

The devices 102 may implement the charging software 113 to determine whether to charge the batteries 112. The charging software 113 may include logic (e.g., hardware, software, firmware, etc.) that may be implemented to prevent the devices 102 from charging the batteries 112 or cause the devices 102 to charge, or resume charging, the batteries 112 based on the one or more parameters. As an example, the charging software 113 may be implemented to cause the devices 102 to discontinue/continue charging the batteries 112 of the devices 102 while the devices 102 are still connected to the power source. In one example, an individual driving a vehicle while the device 102 is charging (e.g., via a USB port, a cigarette lighter, a battery pack attached magnetically, or an enhanced battery pack with an integrated phone case) the battery 112 may experience an accident. Since the accident may involve a hazardous situation that causes the device 102 and battery 112 to be exposed to flammable liquids or material, the charging process may be postponed in order to avoid any of the flammable liquids or material from being triggered, or ignited, by the device 102 charging the battery 112. Thus, after the accident, based on the one or more parameters satisfying one or more parameter thresholds, the charging software 113 may cause the device 102 to discontinue charging the battery 112. In another example, an individual on an airplane or a hot air balloon may experience an altitude change (e.g., determined via the sensors 111) while the device 102 is charging the battery 112. For example, the battery 112 may experience an increased risk of igniting as the altitude increases (e.g., due to the sudden change in altitude and barometric pressure). Thus, the charging software 113 may cause the device 102 to discontinue charging the battery 112 if it is determined that the device 102 is experiencing an extremely high altitude (e.g., an altitude associated with a low air pressure level) and cause the device 102 to resume charging the battery 112 once the device 102 returns to a desired altitude (e.g., an altitude associated with a desired air pressure level). In another example, an individual may be standing next to a heat source (e.g., campfire, bonfire, environment with extremely high temperatures, etc.) while the device 102 is charging the battery 112. Exposure to high temperatures may adversely affect the battery's 112 state of health and increase the risk of the battery 112 igniting. Thus, the charging software 113 may cause the device 102 to discontinue charging the battery 112 if the device 102 is experiencing an extremely high temperature (e.g., determined via the sensors 111). In addition, the device 102 may determine (e.g., via the sensors 111) the presence or absence of ambient light within the vicinity of the device 102 and determine that the device 102 is located in a hazardous environment near the heat source. In another example, an individual may perform one or more movements (e.g., walking, jogging, hiking, exercising, etc.) while the device is charging the battery 112. Exposure to long periods of movements and/or rapid movements may subject the device 102 to mechanical degradation that may adversely affect the battery's 112 state of health. Thus, the charging software 113 may cause the device 102 to discontinue charging the battery 112 if the device 102 is experiencing movements (e.g., determined via the sensors 111) above a threshold (e.g., rapid movements, movements lasting longer than a predetermined duration, etc.). In addition, the device 102 may determine (e.g., via the sensors 111) the presence or absence of audio (e.g., a noisy environment) and determine that the individual may be located in a certain type of environment such as an airport, concert, library, etc. For example, the logic implemented by the charging software 113 may be represented by the function, f(x)=[c]+a+t+1+k+f(r), where c comprises an absolute value of the battery capacity, a comprises accelerometer values (e.g., m/s²), t comprises temperature values ranging from negative to positive values, 1 comprises ambient light values (e.g., simple %), k comprises a current time, and f(r) comprises location coordinates (e.g., GPS coordinates, environment, etc.). It should be understood, that the values represented above are not exhaustive and may include any combination of the one or more parameters.

In an example, the device 102 may experience/receive a power consumption event while initially in a low power or sleep mode and while engaging (e.g. connected to) a power source (e.g., outlet or external battery pack) to recharge the battery 112. The power consumption event may comprise one or more of receiving a notification or a call, causing a display of the device 102 to turn on, or causing the device 102 to power on. As an example, the user may tap on the display screen of the device 102 or press a power button of the device 102 to check one or more notifications, and thus, cause a power consumption spike that drains a portion of the battery's 112 capacity. Based on the power consumption event, the charging software 113 may cause the device 102 to charge the battery 112 via the power source based on a first charge level (e.g., the first charge level is below a first threshold percentage of capacity such as 90%, 80%, etc.) of the battery 112 of the device 102. For example, if the device is below the first threshold percentage of capacity when the device 102 experiences the power consumption event, the device 102 may initiate charging the battery 112. In an example, the charging software 113 may cause the device 102 to charge the battery 112 if the device 102 is connected to the power source for a duration of time (e.g., 30 seconds, 5 minutes, 1 hour, etc.). Based on the battery 112 reaching a second charge level (e.g., a second threshold percentage of capacity such as 90%, 95%, etc.), the charging software 113 may cause the device 102 to discontinue charging the battery 112 via the power source. For example, the second charge level may be greater than the first charge level. The device 102 may determine the one or more parameters associated with the battery 112. The charging software 113 may cause the device 102 to resume charging the battery 112 via the power source based on the one or more parameters satisfying one or more parameter thresholds. For example, the device 102 may determine that it is experiencing one or more movements that is below a movement threshold, an acceleration that is below an acceleration threshold, a temperature that is below a temperature threshold, an air pressure that is below an air pressure threshold, etc. and resume charging the battery 296. In an example, the charging software 113 may cause the device 102 to discontinue charging the battery 112 via the power source based on the battery 112 reaching a third charge level (e.g., third threshold percentage of capacity such as 95%, 99%, etc.). The third charge level may be greater than the first charge level and the second charge level. For example, one or more of the first charge level or the second charge level may comprise a percentage of the third charge level.

In an example, the one or more parameters may be grouped into one or more groups of parameters in order to determine whether to charge the battery 112. For example, the device 102 may determine that it is stationary in an area without light. The device 102 may combine these determinations and determine a time of day indicating that it is night time to determine that it is okay to charge the battery 112. In addition to determining that the device 102 is stationary at night time, the device 102 may also determine that a temperature of the environment exceeds a temperature threshold and prevent the battery 112 from being charged based on the high temperature. The temperature parameter may also be grouped with the lighting/illumination parameter to determine whether to charge the battery 112. The device 102 may determine that it is stationary at night and that a temperature and illumination detected in the environment exceed a threshold, indicating that the device 102 may be in proximity to a fire. Thus, the device 102 may postpone charging the battery 112 based on the indication that the device 102 is in proximity to the fire. The device 102 may determine a first group of parameters (e.g., a first group of the one or more parameters) associated with the battery 112 satisfies one or more first parameter thresholds and a second group of parameters (e.g., a second group of the one or more parameters) associated with the battery 112 satisfies one or more second parameter thresholds based on the first charge level of the battery 112. The charging software 113 may cause the device 102 to charge the battery 112 based on the first group of parameters satisfying the one or more first parameter thresholds and the second group of parameters satisfying the one or more second parameter thresholds. In an example, based on the battery 112 reaching a second charge level, the charging software 113 may cause the device 102 to discontinue charging the battery 112. The second charge level may be greater than the charge level. For example, the charge level may comprise a percentage of the second charge level.

In an example, the device 102 may determine a first parameter satisfies a first parameter threshold first and then subsequently determine whether a second parameter satisfies a second parameter threshold. For example, to minimize the computational complexity of determining whether to charge the battery 112, the device 102 may only proceed forward to initiate charging the battery 112 by determining the parameters in series. For example, the device 102 may first determine whether the device 102 is experiencing a movement or is being moved. If so, the device may next determine a rate of change of the movement, such as an acceleration of the device 102. If the device is experiencing an acceleration above an acceleration threshold, the device 102 may postpone charging the battery 112. Otherwise, the device 102 may initiate charging the battery 112. The device 102 may also initially determine that its altitude has changed, and then determine the rate at which its altitude is changing. For example, a user of the device 102 may have boarded a flight that is taking off and rising in altitude until it reaches a final altitude. If the rate at which the altitude is changing exceeds a rate threshold, the device 102 may postpone charging the battery 112. Otherwise, the device 102 may initiate charging the battery 112. The device 102 may determine a first parameter (e.g., a first parameter of the one or more parameters) associated with the battery 112 satisfies a first parameter threshold based on the first charge level satisfying the charge level threshold. The device 102 may then determine a second parameter (e.g., a second parameter of the one or more parameters) associated with the battery 112 satisfies a second parameter threshold based on the first parameter satisfying the first parameter threshold. The charging software 113 may cause the device 102 to charge the battery 112 based on the second parameter satisfying the second parameter threshold. In an example, based on the battery 112 reaching a second charge level, the charging software 113 may cause the device 102 to discontinue charging the battery 112. The second charge level may be greater than the first charge level. For example, the first charge level may comprise a percentage of the second charge level.

In an example, the device 102 may first determine a change in one or more of the parameters, and then subsequently determine whether a rate of change associated with the one or more of the parameters satisfies a rate threshold to determine whether to charge the battery 112. For example, as discussed above, the device 102 may initially determine whether the device 102 is experiencing a movement or is being moved. If so, the device 102 may next determine a rate of the movement, such as an acceleration of the device 102. If the device 102 is experiencing an acceleration above an acceleration threshold, the device 102 may postpone charging the battery 112. Otherwise, the device 102 may initiate charging the battery 112. The device 102 may determine a change of the one or more parameters associated with the battery 112 based on the first charge level satisfying the charge level threshold. The device 102 may determine a rate of change of the one or more parameters satisfies a rate threshold based on the determination of the change of the one or more parameters. The charging software 113 may cause the device 102 to charge the battery 112 based on the rate of change of the one or more parameters satisfying the rate threshold. In an example, based on the battery 112 reaching a second charge level, the charging software 113 may cause the device 102 to discontinue charging the battery 112. The second charge level may be greater than the first charge level. For example, the first charge level may comprise a percentage of the second charge level.

The communication element 114 may comprise a wireless transceiver configured to transmit and receive wireless communications via a wireless communication network. The communication element 114 may be configured to communicate via a specific network protocol. The communication element 114 may comprise a wireless transceiver configured to communicate via a Wi-Fi network. The device 102 may communicate with the computing device 104, and/or a user device via the communication element 114.

The devices 102 may be associated with user identifiers or device identifiers 115. As an example, the device identifiers 115 may be any identifier, token, character, string, or the like, for differentiating one user or user device (e.g., a device 102) from another user or user device. The device identifier 115 may identify a user or user device as belonging to a particular class of users or user devices. As an example, the device identifier 115 may comprise information relating to the user device such as a manufacturer, a model or type of device, a service provider associated with the device 102, a state of the device 102, a locator, and/or a label or classifier. Other information can be represented by the device identifiers 115.

The device identifiers 115 may comprise address elements 116 and service elements 117. The address elements 116 may comprise or make available an internet protocol address, a network address, a media access control (MAC) address, an Internet address, or the like. As an example, the address elements 116 may be relied upon to establish a communication session between the devices 102 and the computing device 104 or other devices and/or networks. As an example, the address elements 116 may be used as an identifier or locator of the user devices 102. The address elements 116 may be persistent for a particular network.

The service elements 117 may comprise identification of the service providers associated with the devices 102 and/or with the class of devices 102. The class of the devices 102 may be related to a type of device, a capability of a device, a type of service being offered, and/or a level of service (e.g., a business class, a service tier, a service package, etc.). As an example, the service elements 117 may comprise information relating to or made available by a communication service provider (e.g., an Internet service provider) that is offering or enabling data flow such as communication services to the devices 102. As an example, the service elements 117 may comprise information relating to a preferred service provider for one or more particular services relating to the devices 102. The address elements 116 may be used to identify or retrieve data from the service elements 117, or vice-versa. As an example, one or more of the address elements 116 and the service elements 117 can be stored remotely from the devices 102 and retrieved by one or more devices such as the devices 102 and the computing device 104. Other information can be represented by the service element 117.

The computing device 104 may be a server, or a centralized device, for communicating with the devices 102. In an example, the computing device 104 may communicate with the devices 102 for offering data and/or services. For example, the computing device 104 may offer services such as network (e.g., Internet) connectivity, network printing, media management (e.g., a media server), interference management, content services, streaming services, broadband services, or other network-related services.

The computing device 104 may allow the devices 102 to interact with remote resources such as data, devices, and files. As an example, the computing device 104 may be configured as (or disposed at) a central location (e.g., a headend, or a processing facility), which can receive content (e.g., data, input programming) from multiple sources. The computing device 104 may be a separate/remote device from the headend, for example. The computing device 104 can combine content from the multiple sources and may distribute the content to user (e.g., subscriber) locations via a distribution system.

The computing device 104 may be configured to manage the communication between the devices 102 and a storage system (e.g., a database 120) for sending and receiving data there in between. As an example, the database 120 may store a plurality of files, user identifiers or records, or other information. As an example, the devices 102 may request and/or retrieve one or more files from the database 120. The database 120 may store information relating to the devices 102 such as the address elements 116 and/or the service elements 117. As an example, the computing device 104 may obtain the device identifiers 115 from the devices 102 and retrieve information from the database 120 such as the address elements 116 and/or the service elements 117. As an example, the computing device 104 may obtain the address elements 116 from the devices 102 and may retrieve the service elements 117 from the database 120, or vice versa. Any information can be stored in and retrieved from the database 120. The database 120 can be disposed remotely from the computing device 104 and accessed via direct or indirect connection. The database 120 can be integrated with the computing device 104 or some other device or system.

The computing device 104 may have an address element 122 and a service element 124, which may be stored in the database 122. The address element 122 may comprise or provide an internet protocol address, a network address, a media access control (MAC) address, an Internet address, or the like. The address element 122 may be relied upon to establish a communication session between the computing device 104 and the device 102 or other devices and/or networks. The address element 122 may be used as an identifier or locator of the computing device 104. The address element 122 may be persistent for a particular network.

The service element 124 may comprise an identification of a service provider associated with the computing device 104 and/or with the class of computing device 104. The class of the computing device 104 may be related to a type of device, capability of device, type of service being provided, and/or a level of service (e.g., business class, service tier, service package, etc.). The service element 124 may comprise information relating to or provided by a communication service provider (e.g., Internet service provider) that is providing or enabling data flow such as communication services to the computing device 104. The service element 124 may comprise information relating to a preferred service provider for one or more particular services relating to the computing device 104. Other information may be represented by the service element 124.

The computing device 104 may have an identifier 126, which may be stored in the database 122. The identifier 126 may be or relate to an Internet Protocol (IP) Address, a Media Access Control (MAC) address, or the like. The identifier 126 may be a unique identifier for facilitating wired and/or wireless communications with the device 102. The identifier 126 may be associated with a physical location of the computing device 104.

The database may further include battery data 128 and battery software 130. The battery data 128 may contain data related to one or more batteries (e.g., the batteries 112), as well as data related to the power usage of one or more devices (e.g., the devices 102). The battery data 128 may include state of health data associated with the devices' 102 batteries 112. In an example, the computing device 104 may include a cloud-based server wherein the computing device 104 may perform one or more of the functions of the charging software 113 of the device 102. For example, the devices 102 may communicate with the computing device 104, wherein the computing device 102 may implement the battery software 130 to determine whether to cause the devices 102 to charge the batteries 112. The charging software 130 may include logic (e.g., hardware, software, firmware, etc.) that may be implemented to cause the computing device 104 to communicate with the devices 102 to cause the devices 102 charge, or discontinue or resume charging, the batteries 112 based on the one or more parameters. For example, one or more of the devices 102 may discontinue charging the batteries 112 based on the batteries 112 reaching a desired charge level, wherein the charging software 130 may cause, via the computing device 104, one or more of the devices 102 to resume charging the batteries 112 based on one or more of the parameters satisfying the one or more parameter thresholds. For example, the one or more parameters may be grouped into one or more groups of parameters, wherein the charging software 130 may cause, via the computing device 104, one or more of the devices 102 to charge, or resume charging, the batteries 112 based on one or more groups of parameters satisfying one or more parameter thresholds. For example, the one or more parameters may be determined in series, wherein the charging software 130 may cause, via the computing device 104, one or more of the devices 102 to charge, or resume charging, the batteries 112 based on determining that a first parameter satisfies a first parameter threshold first and then subsequently determining that a second parameter satisfies a second parameter threshold. For example, the charging software 130 may cause, via the computing device 104, one or more of the devices 102 to charge, or resume charging, the batteries 112 based on first determining a change in one or more of the parameters and then subsequently determining that a rate of change associated with the one or more of the parameters satisfies a rate threshold.

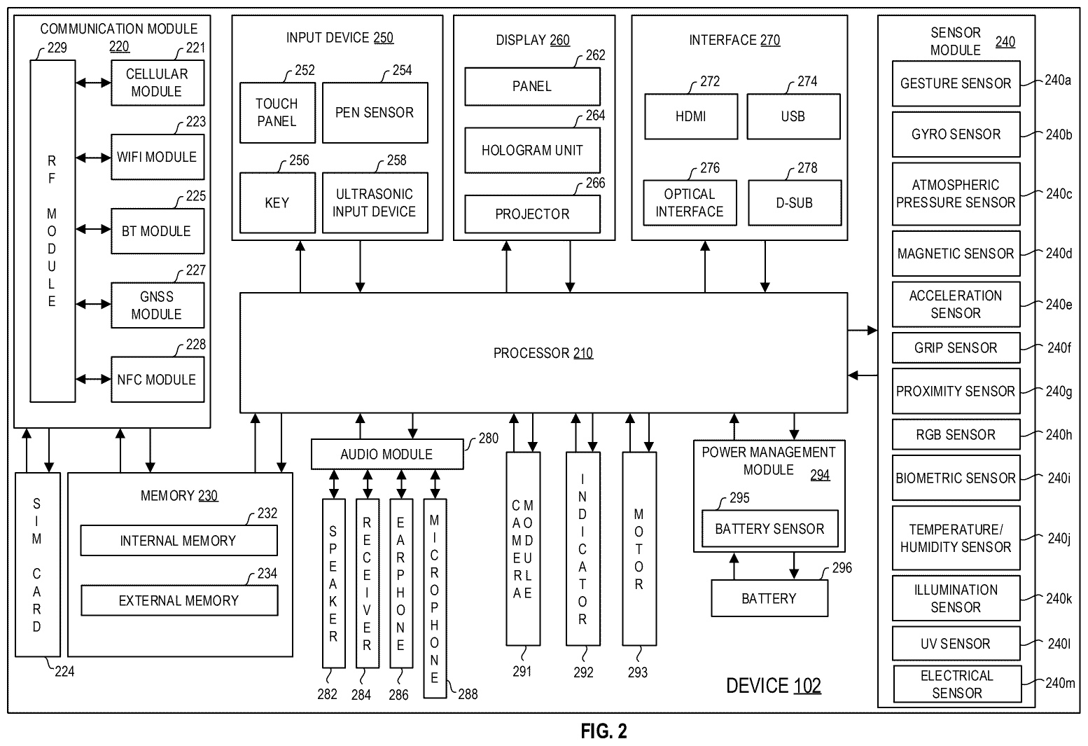

FIG. 2 shows an example system architecture of the device 102 that may be configured to determine whether to charge a battery (e.g., battery 112) of the device 102. The device 102 may comprise one or more processors (e.g., Application Processors (APs)) 210, a communication module 220, a subscriber identity module 224, a memory 230, a sensor module 240, an input unit 250, a display 260, an interface 270, an audio module 280, a camera module 291, an indicator 292, a motor 293, a power management module 294, a battery sensor 295 and/or a battery 296 (e.g., battery 112). In some examples, such as a tablet, an Internet of Things (IoT) device, a wearable device and so forth, the electronic device 101 may exclude the subscriber identity module 124.

The processor 210 may be configured to control a plurality of hardware and/or software constitutional elements connected to the processor 210 by driving, for example, an operating system or an application program, and may process a variety of data including multimedia data and may perform an arithmetic operation. The processor 210 may be implemented, for example, as a System on Chip (SoC), a controller a Central Processing Unit (CPU) or any processing element. The processor 210 may further comprise a Graphic Processing Unit (GPU) and/or an Image Signal Processor (ISP). The processor 210 may comprise one or more parts (e.g., a cellular module 221) of the aforementioned constitutional elements of FIG. 2. The processor 210 may process an instruction and/or data, which is received from at least one of different constitutional elements (e.g., a non-volatile memory), by loading the instruction and/or data to a volatile memory (e.g., the memory 230) and may store a variety of data in a non-volatile memory (e.g., the memory 230).

The communication module 220 may comprise, for example, the cellular module 221, a Wi-Fi module 223, a Bluetooth (BT) module 225, a Global Navigation Satellite System (GNSS) module 227 (e.g., a GPS module, a Gleans module, a Bijou module, or a Galileo module), a Near Field Communication (NFC) module 228, and a Radio Frequency (RF) module 229.

The cellular module 221 may be configured provide a voice call, a video call, a text service, an internet service, a data service, or the like through a communication network. The cellular module 221 may identify and authenticate the device 102 in the communication network by using the subscriber identity module (e.g., a Subscriber Identity Module (SIM) card) 224. The cellular module 221 may perform at least some functions that may be provided by the processor 110. The cellular module 221 may comprise a Communication Processor (CP).

Each of the Wi-Fi module 223, the BT module 225, the GNSS module 227, or the NFC module 228 may comprise, for example, a processor for processing data transmitted/received via a corresponding module. According to a certain exemplary embodiment, at least some (e.g., two or more) of the cellular module 221, the Wi-Fi module 223, the BT module 225, the GPS module 227, and the NFC module 228 may be comprised in one Integrated Chip (IC) or IC package.

The RF module 229 may be configured transmit and/or receive a communication signal (e.g., a Radio Frequency (RF) signal). The RF module 229 may comprise a transceiver, a Power Amp Module (PAM), a frequency filter, a Low Noise Amplifier (LNA), an antenna, or the like. At least one of the cellular module 221, the Wi-Fi module 223, the BT module 225, the GPS module 227, and the NFC module 228 may transmit and/or receive an RF signal via a separate RF module.

The BT module 225 may be configured to communicate (e.g., pair with) with another device (e.g., a wearable device, a microphone, a headset, etc.). For example, the device 102 may communicate with the another electronic device to determine whether to charge the battery 296 of the device 102. As an example, the device 102 may be configured to control the another device by communicating with the another device via the BT module 225.

The subscriber identity module 224 may comprise, for example, a card including the subscriber identity module and/or an embedded SIM, and may comprise unique identification information (e.g., an Integrated Circuit Card Identifier (ICCID)) or subscriber information (e.g., an International Mobile Subscriber Identity (IMSI)).

The memory 230 may be configured to store one or more application programs, including, for example, an application program to determine whether to charge a battery 296 of the device 102. The memory 130 may be further configured to store data. For example, the memory 130 may store data related to one or more parameters associated with the device 102 and/or battery 296. The one or more parameters may comprise one or more of a movement of the device 102, an acceleration of the device 102, an orientation of the device 102, a rate of change of an orientation of the device 102, an altitude of the device 102, a rate of change of an altitude of the device 102, a temperature of the device 102, a rate of change of the temperature, level of illumination detected by the device 102, a volume level of sound detected by the device 102, air pressure, a rate of change of air pressure 102, a moisture level of the device 102, a time of day 102, a location of the device 102, combinations thereof, and the like. The memory 230 may comprise, for example, an internal memory 232 or an external memory 234. The internal memory 232 may comprise, for example, at least one of a volatile memory (e.g., a Dynamic RAM (DRAM), a Static RAM (SRAM), a Synchronous Dynamic RAM (SDRAM), etc.) and a non-volatile memory (e.g., a One Time Programmable ROM (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory, a NOR flash memory, etc.), a hard drive, or a Solid State Drive (SSD)).

The external memory 234 may further comprise a flash drive, for example, Compact Flash (CF), Secure Digital (SD), Micro Secure Digital (Micro-SD), Mini Secure digital (Mini-SD), extreme Digital (xD), memory stick, or the like. The external memory 234 may be operatively and/or physically connected to the device 102 via various interfaces.

The sensor module 240 may be used by the device 102 to determine (e.g., measure) the one or more parameters associated with the device 102 and/or the battery 296 and convert the determined/measured parameters into an electric signal. The sensor module 240 may comprise, for example, at least one of a gesture sensor 240a, a gyro sensor 240b, an atmospheric pressure sensor 240c, a magnetic sensor 240d, an acceleration sensor 240e, a grip sensor 240f, a proximity sensor 240g, a color sensor 240h (e.g., a Red, Green, Blue (RGB) sensor), a biometric sensor 240i, a temperature/humidity sensor 240j, an illumination sensor 240k, an Ultra Violet (UV) sensor 240l, and an electrical sensor 240m. The biometric sensor 240i may be an optical sensor configured to detect ambient light and/or light reflected by an external object (e.g., a user's finger), and which is converted into a specific wavelength band by means of a light converting member. Additionally or alternatively, the sensor module 240 may comprise, for example, an E-nose sensor, an ElectroMyoGraphy (EMG) sensor, an ElectroEncephaloGram (EEG) sensor, an ElectroCardioGram (ECG) sensor, an Infrared (IR) sensor, an iris sensor, and/or a fingerprint sensor. The sensor module 240 may further comprise a control circuit for controlling at least one or more sensors comprised therein. In an example, the device 102 may further comprise a processor configured to control the sensor module 240 either separately or as one part of the processor 210, and may control the sensor module 240 while the processor 210 is in a sleep state.

The electrical sensor 240m may be any sensor configured to determine one or more properties of the device 102 and/or the environment surrounding the device 102. For example, the electrical sensor 140m may be a heart rate sensor, a glass break sensor, a sensor that indicates whether a door is open or closed, a smoke sensor, a gas sensor (e.g., a carbon monoxide sensor), and so forth.

The input device 250 may comprise, for example, a touch panel 252, a (digital) pen sensor 254, a key 156, or an ultrasonic input device 258. The touch panel 252 may be configured to recognize a touch input, for example, by using at least one of an electrostatic type, a pressure-sensitive type, and/or an ultrasonic type. In addition, the touch panel 252 may further comprise a control circuit. The touch panel 252 may further be configured to provide the user with a tactile reaction via a tactile layer and/or provide the user with a tactile sensation via one or more electrical signals.

The (digital) pen sensor 254 may be, for example, one part of a touch panel, or may comprise an additional sheet for recognition. The key 256 may be, for example, a physical button, an optical key, a keypad, and/or a touch key. The ultrasonic input device 258 may detect an ultrasonic wave generated from an input means through a microphone (e.g., a microphone 188) to confirm data corresponding to the detected ultrasonic wave.

The display 260 may comprise a panel 262, a hologram unit 264, or a projector 266. The panel 162 may be implemented, for example, in a flexible, transparent, or wearable manner. The panel 162 may be constructed as one module with the touch panel 152. The panel 162 may comprise a pressure sensor (or a force sensor) capable of measuring strength of pressure for a user's touch. The pressure sensor may be implemented in an integral form with respect to the touch panel 252, or may be implemented as one or more sensors separated from the touch panel 252.

The hologram unit 264 may use an interference of light and show a stereoscopic image in the air. The projector 266 may display an image by projecting a light beam onto a screen. The screen may be located, for example, inside or outside the device 102. According to one exemplary embodiment, the display 260 may further comprise a control circuit for controlling the panel 262, the hologram unit 264, or the projector 266.

The interface 270 may comprise, for example, a High-Definition Multimedia Interface (HDMI) 272, a Universal Serial Bus (USB) 274, an optical communication interface 276, or a D-subminiature (D-sub) 278. Additionally or alternatively, the interface 270 may comprise, for example, a Mobile High-definition Link (MHL) interface, a Secure Digital (SD)/Multi-Media Card (MMC) interface, an Infrared Data Association (IrDA) standard interface, and/or any interface that is capable of sending and/or receiving data and/or signals (e.g., communications) to/from the device 102.

The audio module 280 may be configured to bilaterally convert, for example, a sound and/or electric signal. The audio module 280 may convert sound information which is input or output, for example, through a speaker 282, a receiver 284, an earphone 286, the microphone 288, or the like.

The camera module 291 may be, for example, a device for image and/or video capturing. That is, the camera module 291 may be configured to capture still images and or videos. The camera module 291 may comprise one or more image sensors (e.g., a front image sensor, a rear image sensor, etc.), a lens, an Image Signal Processor (ISP), or a flash (e.g., a Light Emitting Diode (LED), xenon lamp, etc.).

The indicator 292 may display a specific state, for example, a booting state, a message state, a charging state, or the like, of the device 102 or one part thereof (e.g., the processor 210). The motor 293 may convert an electric signal into a mechanical vibration, and may generate a vibration or haptic effect.

The power management module 294 may be configured to manage (e.g., based on the implementation of the application program), for example, power of the device 201. According to one exemplary embodiment, the power management module 294 may comprise a Power Management Integrated Circuit (PMIC), a charger Integrated Circuit (IC), or a battery fuel gauge. The PMIC may have a wired and/or wireless charging type. The wireless charging type may comprise, for example, a magnetic resonance type, a magnetic induction type, an electromagnetic type, or the like, and may further comprise an additional circuit for wireless charging, for example, a coil loop, a resonant circuit, a rectifier, or the like.

The power management module 294 may have a battery sensor 295. The battery sensor 295 may be configured to determine the one or more parameters of, or associated with, the device 102 and/or the battery 296. The power management module 294 may utilize the battery sensor 295 to measure, for example, residual quantity of the battery 296 and voltage, current, and temperature during charging. The power management module 294 may be configured to modify the amount of power (e.g., current) provided to the battery 296 during charging based on the one or more parameters determined based on sensor data received from the battery sensor 295. For example, the power management module 294 may modify the amount of power provided to the battery 296 to ensure that the battery 296 is not damaged. For example, the power management module 294 may be configured to implement the application program for preventing the device 102 from charging the battery 296 or causing the device 102 to charge, or resume charging, the battery 296 based on the one or more parameters. In one example, an individual driving a vehicle while the device 102 is charging (e.g., via a USB port, a cigarette lighter, a battery pack attached magnetically, or an enhanced battery pack with an integrated phone case) the battery 296 may experience an accident. Since the accident may involve a hazardous situation that causes the device 102 and battery 296 to be exposed to flammable liquids or material, the charging process may be postponed in order to avoid any of the flammable liquids or material from being triggered, or ignited, by the device 102 charging the battery 296. Thus, after the accident, based on the one or more parameters satisfying one or more parameter thresholds, the power management module 294 may cause the device 102 to discontinue charging the battery 296. In another example, an individual on an airplane or hot air balloon may experience an altitude change (e.g., determined via the sensors 295) while the device 102 is charging the battery 296. For example, the battery 296 may experience an increased risk of igniting as the altitude increases (e.g., due to the sudden change in altitude and barometric pressure). Thus, the power management module 294 may cause the device 102 to discontinue charging the battery 296 if it is determined that the device 102 is experiencing an extremely high altitude (e.g., an altitude associated with a low air pressure level) and cause the device 102 to resume charging the battery 296 once the device 102 returns to a desired altitude (e.g., an altitude associated with a desired air pressure level). In another example, an individual may be standing next to a heat source (e.g., campfire, bonfire, environment with extremely high temperatures, etc.) while the device 102 is charging the battery 296. Exposure to high temperatures may adversely affect the battery's 296 state of health and increase the risk of the battery 296 igniting. Thus, the power management module 294 may cause the device 102 to discontinue charging the battery 296 if the device 102 is experiencing an extremely high temperature (e.g., determined via the sensors 295). In addition, the device 102 may determine (e.g., via the sensors 295) the presence or absence of ambient light within the vicinity of the device 102 and determine that the device 102 is located in a possibly hazardous environment near the heat source. In another example, an individual may perform one or more movements (e.g., walking, jogging, hiking, exercising, etc.) while the device is charging the battery 296. Exposure to long periods of movements and/or rapid movements may subject the device 102 to mechanical degradation that may adversely affect the battery's 296 state of health. Thus, the power management module 294 may cause the device 102 to discontinue charging the battery 296 if the device 102 is experiencing movements (e.g., determined via the sensors 295) above a threshold (e.g., rapid movements, movements lasting longer than a predetermined duration, etc.). In addition, the device 102 may determine (e.g., via the sensors 295) the presence or absence of audio (e.g., a noisy environment) and determine that the individual may be located in a certain type of environment such as an airport, concert, library, etc. For example, the logic implemented by the power management module 294 may be represented by the function, f(x)=[c]+a+t+1+k+f(r), where c comprises an absolute value of the battery capacity, a comprises accelerometer values (e.g., m/s²), t comprises temperature values ranging from negative to positive values, 1 comprises ambient light values (e.g., simple %), k comprises a current time, and f(r) comprises location coordinates (e.g., GPS coordinates, environment, etc.). It should be understood, that the values represented above are not exhaustive and may include any combination of the one or more parameters. As an example, if a first parameter satisfies a threshold (e.g., an extremely high altitude or an extremely high altitude), the remaining parameter may not need to be analyzed.

In an example, the device 102 may experience/receive a power consumption event while initially in a low power or sleep mode while engaging (e.g. connected to) a power source (e.g., outlet or external battery pack) to recharge the battery 296. The power consumption event may comprise one or more of receiving a notification or a call, causing a display of the device 102 to turn on, or causing the device 102 to power on. As an example, the user may tap on the display screen of the device 102 or press a power button of the device 102 to check one or more notification, and thus, causing a power consumption spike that drains a small portion of the battery's 296 capacity. Based on the power consumption event, the power management module 294 may cause the device 102 to charge the battery 296 via the power source based on a first charge level (e.g., below a first threshold percentage of capacity such as 90%, 80%, etc.) of the battery 296 of the device 102. For example, if the device is below the first threshold percentage of capacity, the device may initiate charging the battery. In an example, the power management module 294 may cause the device 102 to charge the battery 296 if the device 102 is connected to the power source for a duration of time (e.g., 30 seconds, 5 minutes, 1 hour, etc.). Based on the battery 296 reaching a second charge level (e.g., a second threshold percentage of capacity such as 90%, 95%, etc.), the power management module 294 may cause the device 102 to discontinue charging the battery 296 via the power source. For example, the second charge level may be greater than the first charge level. The device 102 may determine the one or more parameters associated with the battery 296. The power management module 294 may cause the device 102 to resume charging the battery 296 via the power source based on the one or more parameters satisfying one or more parameter thresholds. For example, the device 102 may determine that it is experiencing one or more movements that is below a movement threshold, an acceleration that is below an acceleration threshold, a temperature that is below a temperature threshold, an air pressure that is below an air pressure threshold, etc. and resume charging the battery 296. In an example, the power management module 294 may cause the device 102 to discontinue charging the battery 296 via the power source based on the battery 296 reaching a third charge level (e.g., third threshold percentage of capacity such as 95%, 99%, etc.). The third charge level may be greater than the first charge level and the second charge level. For example, one or more of the first charge level or the second charge level may comprise a percentage of the third charge level.

In an example, the one or more parameters may be grouped into one or more groups of parameters in order to determine whether to charge the battery 296. For example, the device 102 may determine that it is stationary in an area without light. The device 102 may combine these determinations and determine a time of day indicating that it is night time to determine that it is okay to charge the battery. In addition to determining that the device 102 is stationary at nighttime, the device 102 may also determine that a temperature of the environment exceeds a temperature threshold and prevent the battery 296 from being charged based on the high temperature. The temperature parameter may also be grouped with the lighting/illumination parameter to determine whether to charge the battery 296. The device 102 may determine that it is stationary at night and that a temperature and illumination detected in the environment exceed a threshold, indicating that the device 102 may be in proximity to a fire. Thus, the device 102 may postpone charging the battery 296 based on the indication that the device 102 is in proximity to the fire. The device 102 may determine a first group of parameters (e.g., a first group of the one or more parameters) associated with the battery 296 satisfies one or more first parameter thresholds and a second group of parameters (e.g., a second group of the one or more parameters) associated with the battery 296 satisfies one or more second parameter thresholds based on the charge level of the battery 296. The power management module 294 may cause the device 102 to charge the battery 296 based on the first group of parameters satisfying the one or more first parameter thresholds and the second group of parameters satisfying the one or more second parameter thresholds. In an example, based on the battery 296 reaching a second charge level, the power management module 294 may cause the device 102 to discontinue charging the battery 296. The second charge level may be greater than the first charge level. For example, the first charge level may comprise a percentage of the second charge level.

In an example, the device 102 may determine a first parameter satisfies a first parameter threshold first and then subsequently determine whether a second parameter satisfies a second parameter threshold. For example, to minimize the computational complexity of determining whether to charge the battery 296, the device 102 may only proceed forward to initiate charging the battery 296 by determining the parameters in series. The device 102 may first determine whether the device 102 is experiencing a movement or is being moved. If so, the device may next determine a rate of change of the movement, such as an acceleration of the device 102. If the device is experiencing an acceleration above an acceleration threshold, the device 102 may postpone charging the battery 296. Otherwise, the device 102 may initiate charging the battery 296. The device 102 may also initially determine that its altitude has changed, and then determine the rate at which its altitude is changing. For example, a user of the device 102 may have boarded a flight that is taking off and rising in altitude until it reaches a final altitude. If the rate at which the altitude is changing exceeds a rate threshold, the device 102 may postpone charging the battery 296. Otherwise, the device 102 may initiate charging the battery 296. The device 102 may determine a first parameter (e.g., a first parameter of the one or more parameters) associated with the battery 296 satisfies a first parameter threshold based on the first charge level satisfying the charge level threshold. The device 102 may then determine a second parameter (e.g., a second parameter of the one or more parameters) associated with the battery 296 satisfies a second parameter threshold based on the first parameter satisfying the first parameter threshold. The power management module 294 may cause the device 102 to charge the battery 296 based on the second parameter satisfying the second parameter threshold. In an example, based on the battery 296 reaching a second charge level, the power management module 294 may cause the device 102 to discontinue charging the battery 296. The second charge level may be greater than the first charge level. For example, the first charge level may comprise a percentage of the second charge level.

In an example, the device 102 may first determine a change in one or more of the parameters, and then subsequently determine whether a rate of change associated with the one or more of the parameters satisfies a rate threshold to determine whether to charge the battery 296. For example, as discussed above, the device 102 may initially determine whether the device 102 is experiencing a movement or is being moved. If so, the device 102 may next determine a rate of the movement, such as an acceleration of the device 102. If the device 102 is experiencing an acceleration above an acceleration threshold, the device 102 may postpone charging the battery 296. Otherwise, the device 102 may initiate charging the battery 296. The device 102 may determine a change of the one or more parameters associated with the battery 296 based on the first charge level satisfying the charge level threshold. The device 102 may determine a rate of change of the one or more parameters satisfies a rate threshold based on the determination of the change of the one or more parameters. The power management module 294 may cause the device 102 to charge the battery 296 based on the rate of change of the one or more parameters satisfying the rate threshold. In an example, based on the battery 296 reaching a second charge level, the power management module 294 may cause the device 102 to discontinue charging the battery 296. The second charge level may be greater than the first charge level. For example, the first charge level may comprise a percentage of the second charge level.

The battery 296 may comprise, for example, a rechargeable battery. The battery 296 may be any size and/or type of battery. For example, the battery 296 may be a cylindrical battery (e.g., AAA, C, D, CR2, 2CR5, etc.), a rectangular battery (9 volt, 12 volt, etc.), a button cell battery (e.g., CR927, CR1220, CR2025, etc.), a zinc air cell battery (e.g., AC10, ZA13, A312, etc.), and so forth. The battery 296 may be made of any material such as alkaline, carbon zinc, Lithium-ion (Li-ion), Nickel Cadmium (Ni—Cd), Nickel-Metal Hydride (Ni-MH), Lithium-Manganese Dioxide (LiMnO₂), or any suitable battery. In an example, the battery 212 may comprise a plurality of batteries. For example, the plurality of batteries may be configured in one or more strings of the same batteries in series, parallel, or both series and parallel.

The battery 296 may have a storage capacity, which is the total amount of power (e.g., charge) that the battery 296 can store. The storage capacity of the battery 296 may change over time. For example, the battery 296 may comprise a rechargeable battery, wherein the storage capacity of the battery 296 may change over time as the battery 296 is used. For example, as the battery 296 is used (e.g., power is discharged from the battery 296, the battery 296 is charged, etc.), the capacity of the battery 296 may decrease due to the use. Thus, the capacity of the battery 296 may change over time, which may impact determining the amount of power remaining in the battery 296. Thus, the capacity of the battery 296 may be determined based on the use of the battery 296 to account for any change in the capacity of the battery 296. Accordingly, the device 102 may be configured to take into account the change in the capacity of the battery 296 when determining a remaining power left in the battery 296.

The battery 296 may have a battery life associated with the battery 296. For example, the battery 296 may be a rechargeable battery that has a number of usage cycles (e.g., charged and discharged) that the battery 296 can have before the battery is no longer effective (e.g., does not hold a sufficient charge for the device's 102 intended use of the battery 296). As an example, the battery 296 may have a battery life of 10 usage cycles such that the battery 296 may be discharged and charged a total of 10 times before the battery 296 no longer holds a sufficient charge when fully charged due to a diminished capacity of the battery 296. The battery life of the battery 296 may be indicated by a capacity of the battery 296. For example, when the capacity of the rechargeable battery is diminished (e.g., reduced) to the point of no longer being effective for its intended use, the life of the battery 296 may be considered ended even though the battery 296 is still usable because the battery 296 still holds a charge. Thus, when the battery life satisfies a threshold (e.g., when the capacity is reduced to the point that the threshold is satisfied), a notification may be generated and/or sent to indicate that the battery life of the battery 296 is near the end of the effective life of the battery 296, and the battery 296 needs to be replaced. As an example, when the capacity of the battery 296 is reduced to a percentage (e.g., 50%, 60%, 70%, etc.) as compared to the capacity of the battery 296 when new (e.g., 100%), the notification may be generated and/or sent to indicate the that the battery 296 needs to be replaced.

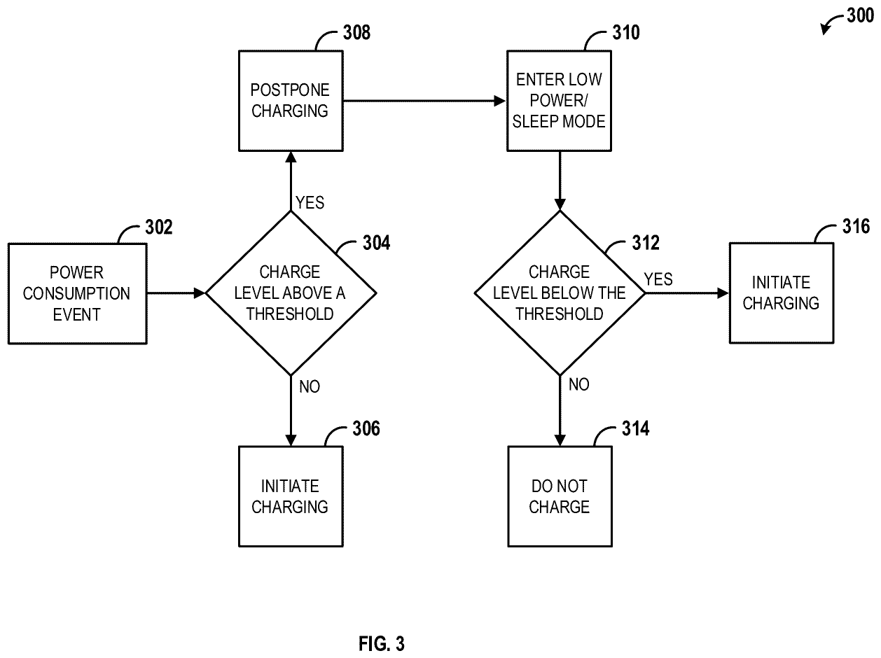

FIG. 3 shows an example process 300 that may be implemented by the device 102 to determine whether to charge a battery (e.g., the battery 112, the battery 296) of the device 102. The device 102 may be connected to a power source for charging the battery (e.g., while the device 102 is in low power or sleep mode). At 302, the device 102 may experience/receive a power consumption event. The power consumption event may comprise one or more of receiving a notification or a call, causing a display of the device 102 to turn on, or causing the device 102 to power on. As an example, a user may tap on the display screen of the device 102 or press a power button of the device 102 to check one or more notifications, and thus, cause a power consumption spike that drains a portion of the battery's capacity. At 304, it may be determined whether a charge level of the battery is above a threshold (e.g., percentage of the battery's capacity above a threshold such as 80%, 85%, 90%, 99%, etc.). If the charge level is not above the threshold, the device 102 may initiate, or resume, charging the battery at 306. If the charge level is above the threshold, the device 102 may postpone charging the battery at 308. At 310, the device 102 may resume low power or sleep mode. At 312, the device 102, while in low power or sleep mode, may determine whether the charge level is below the threshold (e.g., percentage of the battery's capacity below the threshold such as 80%, 85%, 90%, 99%, etc.). If the charge level is above the threshold, the device 102 may continue to postpone charging the battery at 314. If the charge level is below the threshold, the device 102 may initiate, or resume, charging the battery at 316.

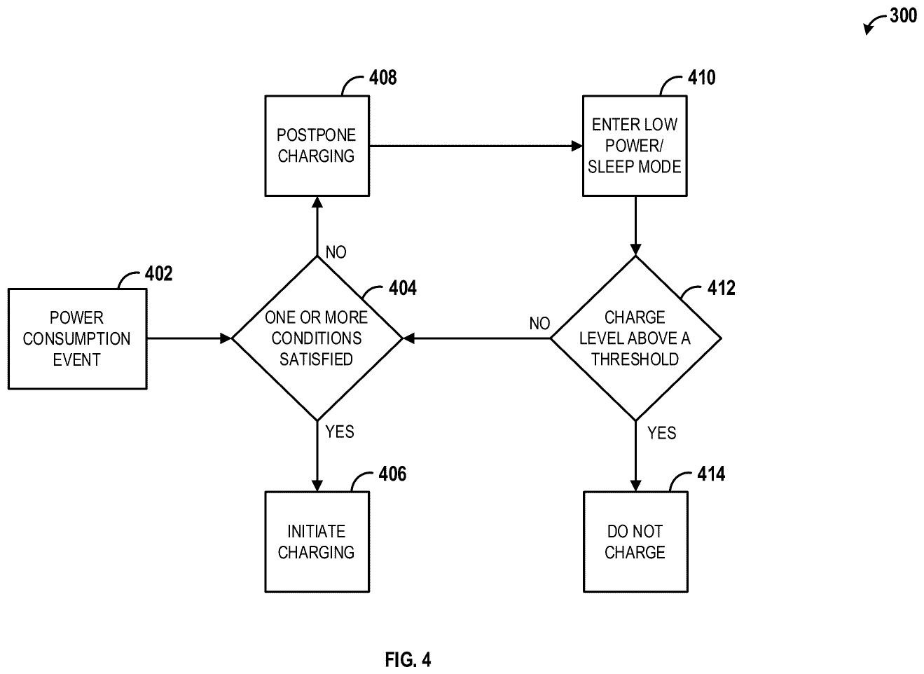

FIG. 4 shows an example process 400 that may be implemented by the device 102 to determine whether to charge a battery (e.g., battery 112, battery 296) of the device 102. The device 102 may be connected to a power source for charging the battery (e.g., while the device 102 is in low power or sleep mode). Steps 402, 406, 408, 410, and 414 may be similar to steps 302, 306, 308, 310, and 314 shown in FIG. 3. At 404, it is determined whether one or more conditions are satisfied. For example, the device 102 may determine one or more parameters associated with the battery and/or the device 102. The one or more parameters may comprise one or more of a movement of the device 102, an acceleration of the device 102, an orientation of the device 102, a rate of change of an orientation of the device 102, an altitude of the device 102, a rate of change of an altitude of the device 102, a temperature of the device 102, a rate of change of the temperature, level of illumination detected by the device 102, a volume level of sound detected by the device 102, air pressure, a rate of change of air pressure 102, a moisture level of the device 102, a time of day 102, a location of the device 102, combinations thereof, and the like. The device 102 may determine whether one or more of the parameters satisfy one or more parameter thresholds. If one or more of the parameters satisfy one or more of the parameter thresholds, the device 102 may initiate charging the battery at 406. If one or more of the parameters do not satisfy one or more of the parameter thresholds, the device 102 may postpone charging the battery at 408.

In an example, the parameters may be grouped into one or more groups of parameters in order to determine whether to charge the battery. For example, the device 102 may determine that it is stationary in an area without light. The device 102 may combine these determinations with a time of day indicating that it is nighttime to determine that it is okay to charge the battery. In another example, in addition to determining that the device 102 is stationary at nighttime, the device 102 may also determine that a temperature of the environment exceeds a temperature threshold and prevent the battery from being charged. In another example, the temperature parameter may be grouped with the lighting/illumination parameter to determine whether to charge the battery. The device 102 may determine that it is stationary at night and that a temperature and illumination detected in the environment exceed a threshold, indicating that the device 102 may be in proximity to a fire. Thus, the device 102 may postpone charging the battery based on the indication that the device 102 is in proximity to the fire.

In an example, the device 102 may determine a first parameter satisfies a first parameter threshold first and then subsequently determine whether a second parameter satisfies a second parameter threshold. For example, it may not always be necessary to utilize all of the parameters to determine whether to charge the battery. To minimize the computational complexity of determining whether to charge the battery, the device 102 may only proceed forward to initiate charging the battery by determining the parameters in series. The device 102 may first determine whether the device 102 is experience a movement or is being moved. If so, the device may next determine a rate of the movement, such as an acceleration of the device 102. If the device is experiencing an acceleration above an acceleration threshold, the device 102 may postpone charging the battery. Otherwise, the device 102 may initiate charging the battery. In another example, the device 102 may initially determine that its altitude has changed, and then determine the rate at which its altitude is changing. For example, a user of the device 102 may have boarded a flight that is taking off and rising in altitude until it reaches a final altitude. If the rate at which the altitude is changing exceeds a rate threshold, the device 102 may postpone charging the battery. Otherwise, the device 102 may initiate charging the battery.

In an example, the device 102 may first determine a change in one or more of the parameters, and then subsequently determine whether a rate of change associated with the one or more of the parameters satisfies a threshold to determine whether to charge the battery. For example, as discussed above the device 102 may initially determine whether the device 102 is experiencing a movement or is being moved. If so, the device may next determine a rate of the movement, such as an acceleration of the device 102. If the device is experiencing an acceleration above an acceleration threshold, the device 102 may postpone charging the battery. Otherwise, the device 102 may initiate charging the battery.

At 412, the device 102, while in low power or sleep mode, may determine whether the charge level is below the threshold (e.g., percentage of the battery's capacity below the threshold such as 80%, 85%, 90%, 99%, etc.). If the charge level is above the threshold, the device 102 may continue to postpone charging the battery at 414. If the charge level is below the threshold, the device 102 may proceed to 404 and determine whether one or more conditions are satisfied.

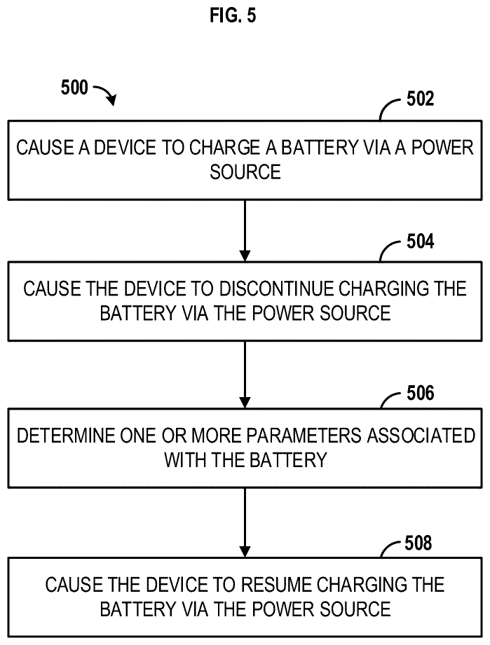

FIG. 5 shows a flowchart of an example method 500 for determining whether to charge a battery of a device. Method 500 may be implemented, for example, by a device (e.g., device 102). At step 502, a device (e.g., device 102) may initiate charging a battery via a power source based on a first charge level (e.g., below a first threshold percentage of capacity such as 90%, 80%, etc.) of a battery of a device. For example, if the device is below the first threshold percentage of capacity, the device may initiate charging the battery. In an example, based on a power consumption event the device may initiate charging the battery based on the first charge level of the battery of the device. The power consumption event may comprise one or more of receiving a notification or a call, causing a display of the device to turn on, or causing the device to power on. As an example, the user may tap on the display screen of the device or press a power button of the device 102 to check one or more notification, and thus, causing a power consumption spike that drains a portion of the battery's capacity. In an example, the device may initiate charging the battery based on a duration time (e.g., 30 seconds, 5 minutes, 1 hour, etc.) the device is connected to the power source and based on the first charge level of the battery.

At step 504, based on the battery reaching a second charge level (e.g., a second threshold percentage of capacity such as 90%, 95%, etc.), the device (e.g., device 102) may discontinue charging the battery via the power source. The second charge level may be greater than the first charge level.

At step 506, one or more parameters may be determined based on the device discontinuing charging the battery. For example, the device (e.g., device 102) may determine the one or more parameters based on the device discontinuing charging the battery. The one or more parameters may comprise one or more of a movement of the device, an acceleration of the device, an orientation of the device, a rate of change of an orientation of the device, an altitude of the device, a rate of change of an altitude of the device, a temperature of the device, a rate of change of temperature, a level of illumination detected by the device, a volume level of sound detected by the device, air pressure, a rate of change of air pressure, a moisture level of the device, a time of day, a location of the device, combinations thereof, and the like.

At step 508, the device (e.g., device 102) may resume charging the battery via the power source based on the one or more parameters satisfying one or more parameter thresholds. In an example, the device may discontinue charging the battery via the power source based on the battery reaching a third charge level. The third charge level may be greater than the first charge level and the second charge level. For example, one or more of the first charge level or the second charge level may comprise a percentage of the third charge level.

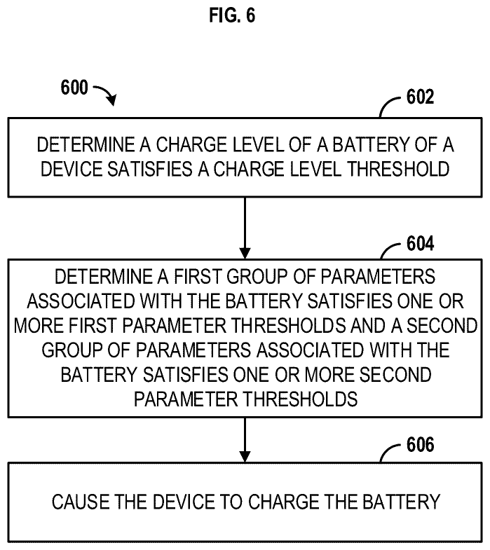

FIG. 6 shows a flowchart of an example method 600 for determining whether to charge a battery of a device. Method 600 may be implemented, for example, by a device (e.g., device 102). At step 602, it may be determined that a charge level of a battery of a device (e.g., device 102) satisfies a charge level threshold based on a power consumption event. For example, the device may determine the charge level of the battery satisfies the charge level threshold based on the power consumption event. The power consumption event may comprise one or more of receiving a notification or a call, causing a display of the device to turn on, or causing the device to power on. In an example, the device may initiate charging the battery based on a duration time (e.g., 30 seconds, 5 minutes, 1 hour, etc.) the device is connected to the power source.

At step 604, it may be determined that a first group of parameters associated with the battery satisfies one or more first parameter thresholds and a second group of parameters associated with the battery satisfies one or more second parameter thresholds based on the charge level of the battery. For example, the device (e.g., device 102) may determine that the first group of parameters associated with the battery satisfies the one or more first parameter thresholds and the second group of parameters associated with the battery satisfies the one or more second parameter thresholds based on the charge level of the battery. One or more of the first group of parameters or the second group of parameters may comprise one or more of a movement of the device, an acceleration of the device, an orientation of the device, a rate of change of an orientation of the device, an altitude of the device, a rate of change of an altitude of the device, a temperature of the device, a rate of change of temperature, a level of illumination detected by the device, a volume level of sound detected by the device, air pressure, a rate of change of air pressure, a moisture level of the device, a time of day, a location of the device, combinations thereof, and the like.

At step 606, the device (e.g., device 102) may initiate charging the battery based on the first group of parameters satisfying the one or more first parameter thresholds and the second group of parameters satisfying the one or more second parameter thresholds. In an example, the device may discontinue charging the battery via the power source based on the battery reaching a second charge level. The second charge level may be greater than the charge level. For example, the charge level may comprise a percentage of the second charge level.

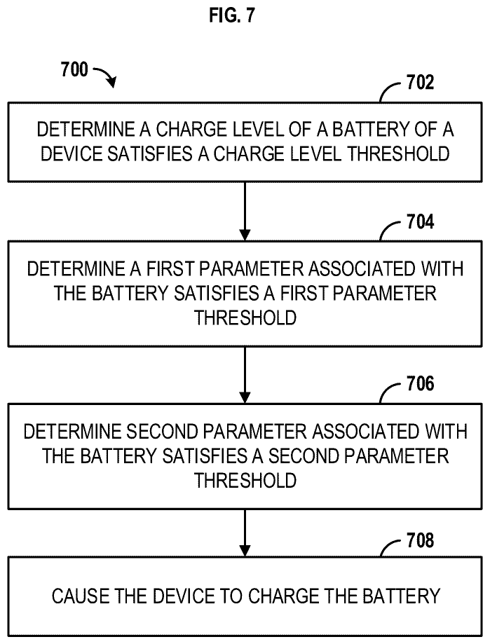

FIG. 7 shows a flowchart of an example method 700 for determining whether to charge a battery of a device. Method 700 may be implemented, for example, by a device (e.g., device 102). At step 702, it may be determined that a charge level of a battery of a device (e.g., device 102) satisfies a charge level threshold based on a power consumption event. For example, the device may determine the charge level of the battery satisfies the charge level threshold based on the power consumption event. The power consumption event may comprise one or more of receiving a notification or a call, causing a display of the device to turn on, or causing the device to power on. In an example, the device may initiate charging the battery based on a duration time (e.g., 30 seconds, 5 minutes, 1 hour, etc.) the device is connected to the power source.

At step 704, it may be determined that a first parameter associated with the battery satisfies a first parameter threshold based on the charge level satisfying the charge level threshold. For example, the device (e.g., device 102) may determine that the first parameter associated with the battery satisfies the first parameter threshold based on the charge level satisfying the charge level threshold. The first parameter may comprise one or more of a movement of the device, an acceleration of the device, an orientation of the device, a rate of change of an orientation of the device, an altitude of the device, a rate of change of an altitude of the device, a temperature of the device, a rate of change of temperature, a level of illumination detected by the device, a volume level of sound detected by the device, air pressure, a rate of change of air pressure, a moisture level of the device, a time of day, a location of the device, combinations thereof, and the like.

At step 706, it may be determined that a second parameter associated with the battery satisfies a second parameter threshold based on the first parameter satisfying the first parameter threshold. For example, the device (e.g., device 102) may determine that the second parameter associated with the battery satisfies the second parameter threshold based on the first parameter satisfying the first parameter threshold. The second parameter may comprise one or more of a movement of the device, an acceleration of the device, an orientation of the device, a rate of change of an orientation of the device, an altitude of the device, a rate of change of an altitude of the device, a temperature of the device, a rate of change of temperature, a level of illumination detected by the device, a volume level of sound detected by the device, air pressure, a rate of change of air pressure, a moisture level of the device, a time of day, a location of the device, combinations thereof, and the like.

At step 708, the device (e.g., device 102) may initiate charging the battery based on the second parameter satisfying the second parameter threshold. In an example, the device may discontinue charging the battery via the power source based on the battery reaching a second charge level. The second charge level may be greater than the charge level. For example, the charge level may comprise a percentage of the second charge level.

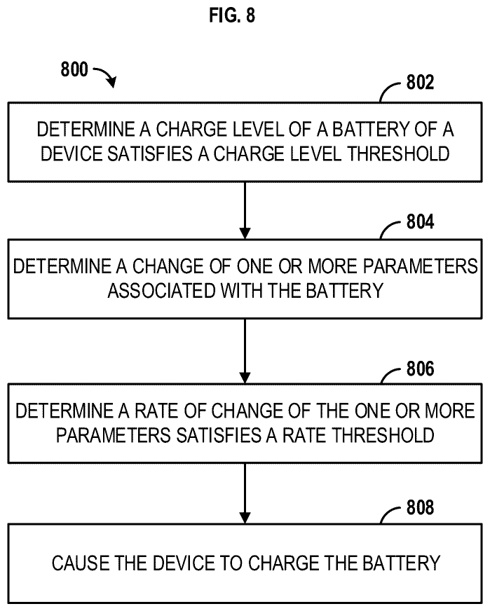

FIG. 8 shows a flowchart of an example method 800 for determining whether to charge a battery of a device. Method 800 may be implemented, for example, by a device (e.g., device 102). At step 802, it may be determined that a charge level of a battery of a device (e.g., device 102) satisfies a charge level threshold based on a power consumption event. For example, the device may determine the charge level of the battery satisfies the charge level threshold based on the power consumption event. The power consumption event may comprise one or more of receiving a notification or a call, causing a display of the device to turn on, or causing the device to power on. In an example, the device may initiate charging the battery based on a duration time (e.g., 30 seconds, 5 minutes, 1 hour, etc.) the device is connected to the power source.

At step 804, a change of one or more parameters associated with the battery may be determined based on the charge level satisfying the charge level threshold. For example, the change of one or more parameters associated with the battery may be determined by the device (e.g., device 102) based on the charge level satisfying the charge level threshold. The one or more parameters may comprise one or more of a movement of the device, an acceleration of the device, an orientation of the device, a rate of change of an orientation of the device, an altitude of the device, a rate of change of an altitude of the device, a temperature of the device, a rate of change of temperature, a level of illumination detected by the device, a volume level of sound detected by the device, air pressure, a rate of change of air pressure, a moisture level of the device, a time of day, a location of the device, combinations thereof, and the like.

At step 806, it may be determined that a rate of change of the one or more parameters satisfies a rate threshold based on the determination of the change of the one or more parameters. For example, the device (e.g., device 102) may determine that the rate of change of the one or more parameters satisfies the rate threshold based on the determination of the change of the one or more parameters. In an example, the device may initially determine whether the device is experiencing a movement or is being moved, and then determine a rate of the movement, such as an acceleration of the device. In an example, the device may initially determine that its altitude has changed, and then determine the rate at which its altitude is changing.

At step 808, the device (e.g., device 102) may initiate charging the battery based on the rate of change of the one or more parameters satisfying the rate threshold. In an example, the device may discontinue charging the battery via the power source based on the battery reaching a second charge level. The second charge level may be greater than the charge level. For example, the charge level may comprise a percentage of the second charge level.

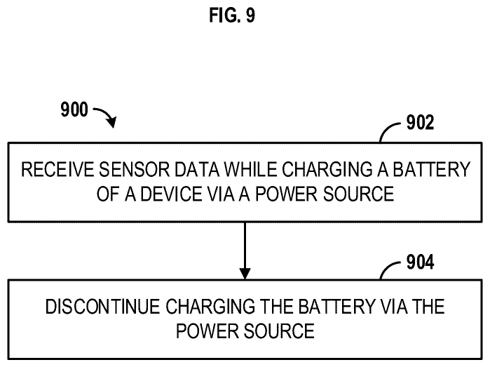

FIG. 9 shows a flowchart of an example method 900 for determining whether to charge a battery of a device. Method 900 may be implemented, for example, by a device (e.g., device 102). At step 902, a device (e.g., device 102) may receive sensor data via one or more sensors while the device charges a battery of the device via a power source. The one or more sensors may comprise one or more of a temperature sensor, an accelerometer, a pressure sensor, an illumination sensor, a microphone or audio sensor, an altimeter, a GPS sensor, a gyroscope sensor, a moisture sensor, a current sensor, a voltage sensor, a resistance sensor, combinations thereof, and the like.

As an example, one or more parameters may be determined based on the sensor data. For example, the device (e.g., device 102) may determine the one or more parameters based on the sensor data. The one or more parameters may comprise one or more of a movement of the device, an acceleration of the device, an orientation of the device, a rate of change of an orientation of the device, an altitude of the device, a rate of change of an altitude of the device, a temperature of the device, a rate of change of temperature, a level of illumination detected by the device, a volume level of sound detected by the device, air pressure, a rate of change of air pressure, a moisture level of the device, a time of day, a location of the device, combinations thereof, and the like.

At step 904, based on a power consumption event, the device (e.g., device 102) may discontinue charging the battery via the power source based on the sensor data. The power consumption event may comprise one or more of receiving a notification or a call, causing a display of the device to turn on, or causing the device to power on. In an example, the device may discontinue charging the battery via the power source based on the one or more parameters satisfying one or more parameter thresholds. Based on the power consumption event, the device may determine the one or more parameters based on the sensor data. In an example, the device may discontinue charging the battery via the power source based on a charge level (e.g., based on the charge level comprising 90% of the battery's capacity or greater) associated with the battery. Based on the power consumption event, the device may determine the charging level based on the sensor data.

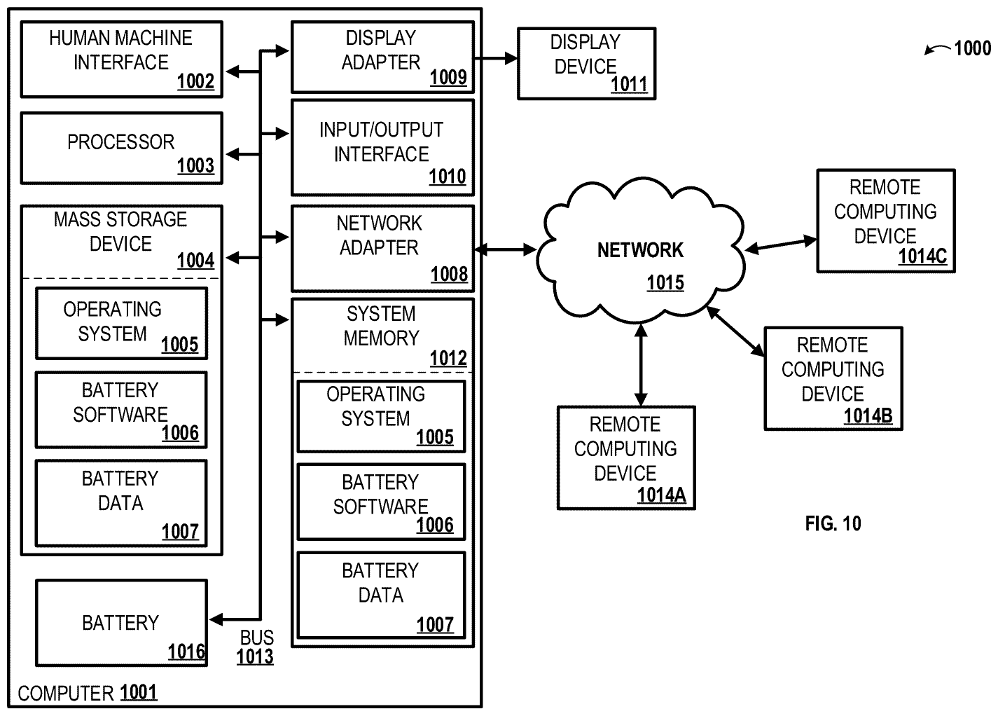

FIG. 10 is a block diagram illustrating an example computing device. The methods and systems can be implemented on a computer 1001 as illustrated in FIG. 10 and described below. By way of example, the device 102, and the computing device 104 of FIG. 1 can be a computer 1001 as illustrated in FIG. 10. Similarly, the methods and systems disclosed can utilize one or more computers to perform one or more functions in one or more locations. FIG. 10 is a block diagram illustrating an exemplary operating environment 1000 for performing the disclosed methods. This exemplary operating environment 1000 is only an example of an operating environment and is not intended to suggest any limitation as to the scope of use or functionality of operating environment architecture. Neither should the operating environment 1000 be interpreted as having any dependency or requirement relating to any one or combination of components illustrated in the exemplary operating environment 1000.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media including memory storage devices.

Further, one skilled in the art will appreciate that the systems and methods disclosed herein can be implemented via a general-purpose computing device in the form of a computer 1001. The computer 1001 can comprise one or more components, such as one or more processors 1003, a system memory 1012, and a bus 1013 that couples various components of the computer 1001 including the one or more processors 1003 to the system memory 1012. In the case of multiple processors 1003, the system can utilize parallel computing.

The bus 1013 can comprise one or more of several possible types of bus structures, such as a memory bus, memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1013, and all buses specified in this description can also be implemented over a wired or wireless network connection and one or more of the components of the computer 1001, such as the one or more processors 1003, a mass storage device 1004, an operating system 1005, battery software 1006, battery data 1007, a network adapter 1008, system memory 1012, an Input/Output Interface 1010, a display adapter 1009, a display device 1011, and a human machine interface 1002, can be contained within one or more remote computing devices 1014A-1014C at physically separate locations, connected through buses of this form, in effect implementing a fully distributed system.

The computer 1001 typically comprises a variety of computer readable media. Exemplary readable media can be any available media that is accessible by the computer 1001 and comprises, for example and not meant to be limiting, both volatile and non-volatile media, removable and non-removable media. The system memory 1012 can comprise computer readable media in the form of volatile memory, such as random access memory (RAM), and/or non-volatile memory, such as read only memory (ROM). The system memory 1012 typically can comprise data such as battery data 1007 and/or program modules such as operating system 1005 and battery software 1006 that are accessible to and/or are operated on by the one or more processors 1003.

The computer 1001 can also comprise other removable/non-removable, volatile/non-volatile computer storage media. By way of example, the computer 1001 can comprise a mass storage device 1004 which can offer non-volatile storage of computer code, computer readable instructions, data structures, program modules, and other data for the computer 1001. For example, a mass storage device 1004 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1004, including by way of example, an operating system 1005 and battery software 1006. One or more of the operating system 1005 and battery software 1006 (or some combination thereof) can comprise elements of the programming and the battery software 1006. Battery data 1007 can also be stored on the mass storage device 1004. Battery data 1007 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 1015.

The user can enter commands and information into the computer 1001 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 1003 via a human machine interface 1002 that is coupled to the bus 1013, but can be connected by other interface and bus structures, such as a parallel port, game port, an IEEE 1394 Port (also known as a Firewire port), a serial port, network adapter 1008, and/or a universal serial bus (USB).

A display device 1011 can also be connected to the bus 1013 via an interface, such as a display adapter 1009. It is contemplated that the computer 1001 can have more than one display adapter 1009 and the computer 1001 can have more than one display device 1011. For example, a display device 1011 can be a monitor, an LCD (Liquid Crystal Display), light emitting diode (LED) display, television, smart lens, smart glass, and/or a projector. In addition to the display device 1011, other output peripheral devices can comprise components such as speakers (not shown) and a printer (not shown) which can be connected to the computer 1001 via Input/Output Interface 1010. Any step and/or result of the methods can be output in any form to an output device. Such output can be any form of visual representation, including, but not limited to, textual, graphical, animation, audio, tactile, and the like. The display 1011 and computer 1001 can be part of one device, or separate devices.

The battery 1016 may comprise any type of battery. For example, the battery 1016 may comprise a rechargeable battery. The battery 1016 may comprise any size, model, and/or type of battery. For example, the battery 1016 may comprise a cylindrical battery (e.g., AAA, C, D, CR2, 2CR5, etc.), a rectangular battery (9 volt, 12 volt, etc.), a button cell battery (e.g., CR927, CR1220, CR2025, etc.), a zinc air cell battery (e.g., AC10, ZA13, A312, etc.), and so forth. The battery 1016 may be made of any material such as alkaline, carbon zinc, Lithium-ion (Li-ion), Nickel Cadmium (Ni—Cd), Nickel-Metal Hydride (Ni-MH), Lithium-Manganese Dioxide (LiMnO₂), or any suitable battery. In an example, the battery 1016 may comprise a plurality of batteries. For example, the plurality of batteries may be configured in one or more strings of the same batteries in series, parallel, or both series and parallel. The battery 1016 may have a storage capacity, which is the total amount of power (e.g., charge) that the battery 1016 can store.

The computer 1001 can operate in a networked environment using logical

connections to one or more remote computing devices 1014A, 1014B, and 1014C. By way of example, a remote computing device 1014A-1014C can be a personal computer, a computing station (e.g., a workstation), a portable computer (e.g., a laptop, a mobile phone, a tablet device), a smart device (e.g., a smartphone, a smart watch, an activity tracker, a smart apparel, a smart accessory), a security and/or monitoring device, a server, a router, a network computer, a peer device, an edge device or other common network node, and so on. Logical connections between the computer 1001 and a remote computing device 1014A-1014C can be made via a network 1015, such as a local area network (LAN) and/or a general wide area network (WAN). Such network connections can be through a network adapter 1008. A network adapter 1008 can be implemented in both wired and wireless environments. Such networking environments are conventional and commonplace in dwellings, offices, enterprise-wide computer networks, intranets, and the Internet.

For purposes of illustration, application programs and other executable program components such as the operating system 1005 are illustrated herein as discrete blocks, although it is recognized that such programs and components can reside at various times in different storage components of the computer 1001, and are executed by the one or more processors 1003 of the computer 1001. An implementation of battery software 1006 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g., a genetic algorithms), swarm intelligence (e.g., an ant algorithms), and hybrid intelligent systems (e.g., expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
causing, based on a first charge level of a battery of a device, the device to charge the battery via a power source;
based on the battery reaching a second charge level, causing the device to discontinue charging the battery via the power source;
determining, based on the device discontinuing charging the battery, one or more parameters associated with the battery; and
causing, based on the one or more parameters satisfying one or more parameter thresholds, the device to resume charging the battery via the power source.

2. The method of claim 1, wherein causing, based on the first charge level of the battery, the device to charge the battery via the power source comprises based on a power consumption event, causing, based on the first charge level of the battery, the device to charge the battery via the power source.

3. The method of claim 2, wherein the power consumption event comprises one or more of receiving a notification or a call, causing a display of the device to turn on, or causing the device to power on.

4. The method of claim 1, wherein causing based on the first charge level of the battery, the device to charge the battery via the power source comprises causing, based on a duration the device is connected to the power source and based on the first charge level of the battery, the device to charge the battery via the power source.

5. The method of claim 1, wherein the second charge level is greater than the first charge level.

6. The method of claim 1, wherein the one or more parameters comprise one or more of a movement of the device, an acceleration of the device, an orientation of the device, a rate of change of an orientation of the device, an altitude of the device, a rate of change of an altitude of the device, a temperature of the device, a rate of change of temperature, a level of illumination detected by the device, a volume level of sound detected by the device, air pressure, a rate of change of air pressure, a moisture level of the device, a time of day, or a location of the device.

7. The method of claim 1, further comprising based on the battery reaching a third charge level, causing the device to discontinue charging the battery via the power source.

8. The method of claim 7, wherein one or more of the first charge level or the second charge level comprises a percentage of the third charge level.

9. A method comprising:
based on a power consumption event, determining a charge level of a battery of a device satisfies a charge level threshold;
determining, based on the charge level of the battery, a first group of parameters associated with the battery satisfies one or more first parameter thresholds and a second group of parameters associated with the battery satisfies one or more second parameter thresholds; and
causing, based on the first group of parameters satisfying the one or more first parameter thresholds and the second group of parameters satisfying the one or more second parameter thresholds, the device to charge the battery.

10. The method of claim 9, wherein the power consumption event comprises one or more of receiving a notification or a call, causing a display of the device to turn on, or causing the device to power on.

11. The method of claim 9, wherein based on the power consumption event, determining the charge level of the battery satisfies the charge level threshold comprises based on the power consumption event, determining, based on a duration the device is connected to a power source, the charge level of the battery satisfies the charge level threshold.

12. The method of claim 9, wherein one or more of the first group of parameters or the second group of parameters comprises one or more of a movement of the device, an acceleration of the device, an orientation of the device, a rate of change of an orientation of the device, an altitude of the device, a rate of change of an altitude of the device, a temperature of the device, a rate of change of temperature, a level of illumination detected by the device, a volume level of sound detected by the device, air pressure, a rate of change of air pressure, a moisture level of the device, a time of day, or a location of the device.

13. The method of claim 9, further comprising based on the battery reaching a second charge level, causing the device to discontinue charging the battery.

14. The method of claim 13, wherein the charge level comprises a percentage of the second charge level.

15. A method comprising:
based on a power consumption event, determining a charge level of a battery of a device satisfies a charge level threshold;
determining, based on the charge level satisfying the charge level threshold, a first parameter associated with the battery satisfies a first parameter threshold;
determining, based on the first parameter satisfying the first parameter threshold, a second parameter associated with the battery satisfies a second parameter threshold; and
causing, based on the second parameter satisfying the second parameter threshold, the device to charge the battery.

16. The method of claim 15, wherein the power consumption event comprises one or more of receiving a notification or a call, causing a display of the device to turn on, or causing the device to power on.

17. The method of claim 15, wherein based on the power consumption event, determining the charge level of the battery satisfies the charge level threshold comprises based on the power consumption event, determining, based on a duration the device is connected to a power source, the charge level of the battery satisfies the charge level threshold.

18. The method of claim 15, wherein the first parameter comprises one or more of a movement of the device, an acceleration of the device, an orientation of the device, a rate of change of an orientation of the device, an altitude of the device, a rate of change of an altitude of the device, a temperature of the device, a rate of change of temperature, a level of illumination detected by the device, a volume level of sound detected by the device, air pressure, a rate of change of air pressure, a moisture level of the device, a time of day, or a location of the device.

19. The method of claim 15, wherein the second parameter comprises one or more of a movement of the device, an acceleration of the device, an orientation of the device, a rate of change of an orientation of the device, an altitude of the device, a rate of change of an altitude of the device, a temperature of the device, a rate of change of temperature, a level of illumination detected by the device, a volume level of sound detected by the device, air pressure, a rate of change of air pressure, a moisture level of the device, a time of day, or a location of the device.

20. The method of claim 15, further comprising based on the battery reaching a second charge level, causing the device to discontinue charging the battery.
